(19) United States
(12) Patent Application Publication
(10) Pub. No.: US 2001/0056382 A1
(43) Pub. Date: Dec. 27, 2001

(54) Commodity selling method and commodity selling apparatus

(75) Inventor: Shigeki Asou, Tokyo (JP)

Correspondence Address: SUGHRUE, MION, ZINN, MACPEAK & SEAS, 2100 Pennsylvania Avenue, N.W., Washington, DC, 20037-3213, US

(73) Assignee: NEC CORPORATION

(21) Appl. No.: 09/879,143

(22) Filed: Jun. 13, 2001

(30) Foreign Application Priority Data
Jun. 15, 2000 (JP) 179930/2000

(51) Int. Cl. G06F 17/60

(52) U.S. Cl. 705/26

(57) ABSTRACT

In on-line shopping, the prices of commodities and/or services are differentiated according to the means of purchase each user can opt for and further promotion of the commodities and/or services is thereby made possible.

When an order for a commodity is transmitted from a terminal 10 via an NSP 20 and the Internet 30, the NSP 20 via which the order has been transmitted is identified according to the transmitted IP address. The numbers of commodity buyers having ordered commodities via NSPs 20 are accumulated for each NSP in a database (not shown) in the company 40, and the commodity price is determined according to the number of users having bought commodities via the identified NSP 20.

### BACKGROUND OF THE INVENTION

1. Field of the Invention

The present invention relates to a commodity selling method and a commodity selling apparatus for use in on-line shopping via the Internet.

2. Description of the Related Art

In recent years, the Internet and personal computers have come into rapidly expanding use, enabling individual persons to easily establish connection to the Internet wherever they may be. Also, in connection with that, a quickly increasing number of companies have launched web pages on the Internet, and are using such web pages for providing information or selling commodities or services.

Since so-called on-line shopping, i.e. selling commodities or services through a web page, enables consumers to easily buy commodities or services even while staying at home, it is finding an increasing number of users.

In usual on-line shopping, a user wishing to buy a commodity or the like first connects his or her terminal to a network service provider (NSP) providing the service of connection to the Internet, then accesses a page operated by a company selling the commodity or the like (shopping page), and causes the shopping page, on which commodities and services are displayed, to be displayed on the screen of the terminal.

The user designates a desired one of the commodities and services offered on the shopping page displayed on the terminal screen, enters customer information including his or her name, address, telephone number and e-mail address together with the method of paying the price, and transmits these items of information to the company offering the commodities and services.

The company offering the commodities and services accepts the order according to the information transmitted from the terminal, and sells the ordered item to the buyer.

Incidentally, in conventional on-line shopping, the price of any commodity or service is unilaterally determined by the seller and, even if a price discount is offered, the seller still unilaterally determines the discount price at which the commodity or service is to be offered.

Therefore, unlike in buying a commodity or the like elsewhere, its price does not vary with the means of purchase (channel of purchase), resulting in the problem that, even if the user wants to buy the item at a lower price, there is no way of bargaining. Although there is proposed a commodity selling method by which the price is set on the basis of the user's preference, the minimum price is set by the company or the like offering the commodity or service, and no further bargaining beyond the minimum price is possible.

There is another problem with conventional on-line shopping that, as the commodities and services are advertised solely by the seller company, their further promotion is possible only by the company's own efforts.

### SUMMARY OF THE INVENTION

The present invention, attempted in view of the problems with the prior art noted above, is intended to provide a commodity selling method and a commodity selling apparatus permitting the prices of commodities and/or services offered for on-line shopping to be differentiated according to the means of purchase each user can opt for and thereby making possible further promotion of the commodities and/or services.

According to an aspect of the present invention, there is provided a commodity selling method comprising steps of: accepting a request for connection from a terminal unit via one of a plurality of NSPs; identifying the NSP via which the request for connection came; and setting the price of a commodity according to the identified NSP.

The identification of the NSP may as well be based on the IP address of the terminal unit contained in the request for connection, and the setting of the price of the commodity may as well be based, with respect to each of the plurality of NSPs, on the number of buyers having bought commodities in the past via the NSP.

According to another aspect of the present invention, there is provided a commodity selling apparatus comprising: a receiving device for accepting a request for connection from a terminal unit via one of a plurality of NSPS; an identifying device for identifying the NSP via which the request for connection came; and a setting device for setting the price of a commodity according to the identified NSP.

The identifying device may as well identify the NSP on the basis of the IP address of the terminal unit contained in the request for connection, and the setting device may as well set the price of the commodity, with respect to each of the plurality of NSPs, on the basis of the number of buyers having bought commodities in the past via the NSP.

According to still another aspect of the present invention, there is provided a commodity selling program, the program enabling a computer to execute: processing to accept a request for connection from a terminal unit via one of a plurality of NSPs; processing to identify the NSP via which the request for connection came; and processing to set the price of a commodity according to the identified NSP.

The identification of the NSP may as well be based on the IP address of the terminal unit contained in the request for connection, and the setting of the price of the commodity may as well be based, with respect to each of the plurality of NSPs, on the number of buyers having bought commodities in the past via the NSP.

### BRIEF DESCRIPTION OF THE DRAWINGS

Other features and advantages of the invention will become more apparent from the detailed description hereunder, when taken in conjunction with the accompanying drawings, wherein:

FIG. 1 illustrates the overall configuration of preferred embodiments of the present invention;

FIG. 2 is a flow chart showing how a first preferred embodiment of the invention operations;

FIG. 3 is a flow chart showing how a second preferred embodiment of the invention operations; and

FIG. 4 illustrates the overall configuration of a variation of the preferred embodiments of the invention.

### DETAILED DESCRIPTION OF THE PREFERRED EMBODIMENTS

Preferred embodiments of the present invention will be described in detail below with reference to the accompanying drawings.

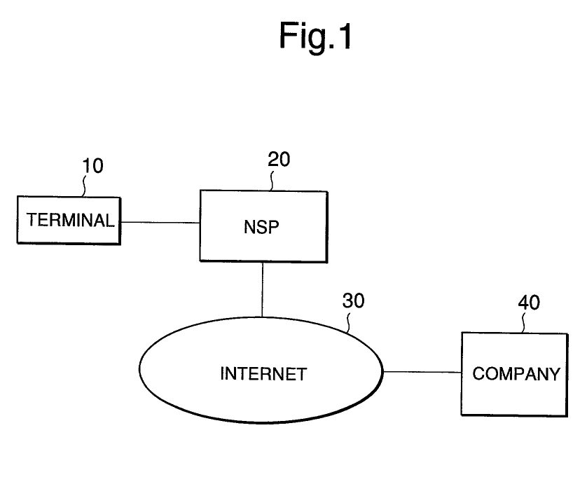

FIG. 1 illustrates the overall configuration of a commodity selling system to which the invention is applied.

Referring to FIG. 1, this embodiment of the invention is configured of a terminal 10, which is a data processing unit, such as a personal computer operated by a user; a commodity selling company (hereinafter to be referred to as simply the company) 40, configured to be connectable to the Internet 30, for providing information to the terminal 10 and, when an order for a commodity or the like is received from the terminal 10, selling the commodity or the like to the user of the terminal 10; and an NSP 20 for managing connection between the terminal 10 and the Internet 30. Here, the NSP 20 and the company 40 are provided with a server computer each, equipped with a CPU, storage units including a hard disk and a communication device for interfacing with the Internet among other items. In the server computer installed at the NSP 20, a storage unit stores a program for causing the server computer to execute the following steps of processing by the NSP 20, and the CPU reads the program onto a main memory and processes it. In the server computer installed at the company 40, a storage unit stores a program for causing the server computer to execute the following steps of processing by the company 40, and the CPU reads the program onto a main memory and processes it. Although there are only one each of the terminal 10, the NSP 20 and the company 40 in the illustration, it is assumed that a plurality each of terminals, NSPs and companies are connected to the Internet 30.

Commodity selling methods for use by the commodity selling system having the above-described configuration will be described below.

### First Preferred Embodiment

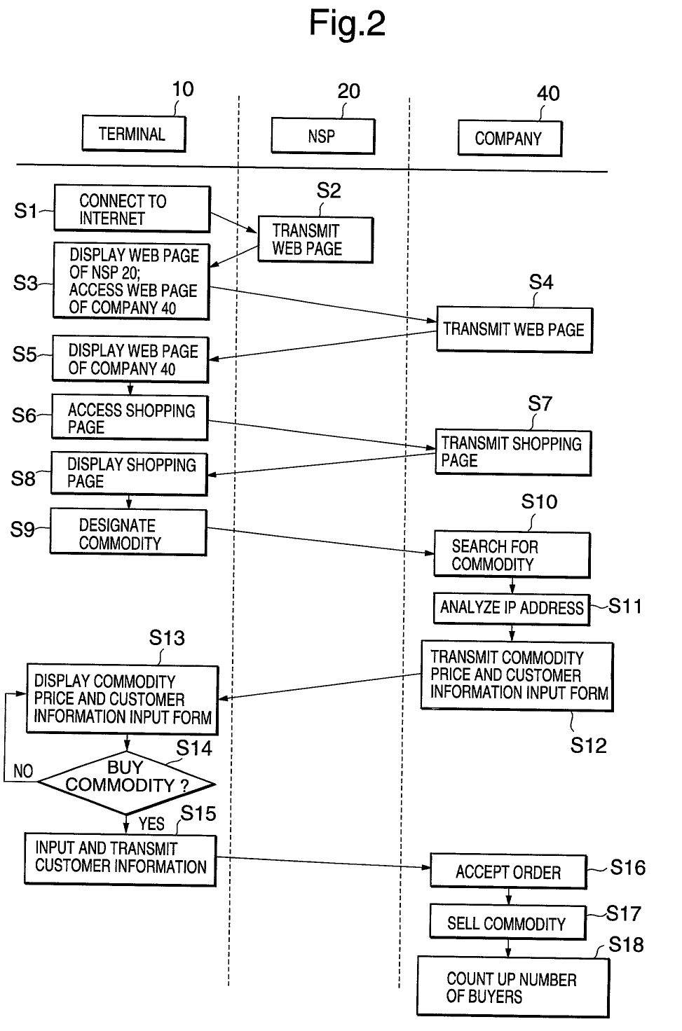

FIG. 2 is a flow chart for describing how a commodity selling method constituting a first preferred embodiment of the invention operates in the commodity selling system illustrated in FIG. 1.

A user, when to do on-line shopping, operates his or her terminal 10 to instruct establishment of connection to the Internet 30 (step S1).

The NSP 20, having a contract with the user of the terminal 10, transmits its web page to the terminal 10 when the terminal 10 instructs establishment of connection to the Internet 30 (step S2).

When the web page of the NSP 20, transmitted from the NSP 20, is displayed on the screen of the terminal 10, the user accesses the web page of the company 40 on which to do on-line shopping (step S3).

Then, the web page of the company 40 is transmitted to the terminal 10 (step S4), and displayed on the screen of the terminal 10 (step S5).

After that, when the user accesses a shopping page of the company 40 whose link is pasted onto the web page of the company 40 (step S6), the shopping page of the company 40 is transmitted to the terminal 10 (step S7) and displayed on the screen of the terminal 10 (step S8).

When the user designates a desired commodity out of the shopping page displayed on the screen of the terminal 10 (step S9), the company 40 searches for the designated commodity (step S10).

Here, the terminal 10 is provided in advance by the NSP 20 with an IP (Internet Protocol) address for identifying the terminal 10, and the IP address is transmitted, together with other information transmitted from the terminal 10, to the company 40. As the IP address is set by the NSP 20 and given to the terminal 10, the NSP via which the access has been made can be identified according to the transmitted IP address. Then, at the company 40, the IP address transmitted from the terminal 10 together with the commodity designation is analyzed, and the NSP via which the terminal 10 has accessed the company 40 is identified accordingly (step S11). The company 40, on the basis of the number of commodity buyers via the identified NSP, offers a discount price for an order placed via an NSP via which many users have bought commodities so far. It is conceivable, for instance, to set a discount rate for each NSP according to the number of commodity buyers in the past or to discount the prices of commodities ordered via an NSP via which a greater number of buyers than a predetermined level have placed orders. The number of commodity buyers is accumulated for each NSP in a database (not shown) in the company 40.

On the basis of identification at step S11, the price of the commodity price set for the particular NSP is transmitted, together with a customer information input form to be filled with customer information, to the terminal 10 (step S12).

The commodity price and the customer information input form transmitted from the company 40 are displayed on the screen of the terminal 10 (step S13).

If the user, looking at the commodity price displayed on the screen of the terminal 10, wishes to buy the commodity (step S14), the user will enter his or her customer information into the customer information input form displayed on the screen of the terminal 10, and transmits it to the company 40 (step S15). Then the company 40 accepts the order for the designated commodity (step S16), and the commodity is sold to the user of the terminal 10 (step S17).

Then, 1 is added to the number of commodity buyers via the NSP 20, accumulated in the database (step S18).

This enables the user, when doing on-line shopping via a specific NSP, to buy the commodity at a lower price than he or she would if it were bought by on-line shopping via another NSP.

This also enables the NSP 20 to attract more members with the price discounts for commodities it handles.

Moreover, if the NSP 20 actively advertises commodities to enlarge the membership, it can further strengthen the promotion of commodities.

Or, if it is advertised that users doing on-line shopping via a specific NSP enjoy discounts on the prices of commodities they buy, this will add to effective promotion of the commodities.

The price discounts on commodities conceivably could be financed with expenditure from the company 40's advertising budget or promotional budget. It is also possible for the company 40 to supply its commodities at undiscounted prices and for the NSP 20 to finance the discounts with, conceivably, part of the increased advertising revenue resulting from the expanded membership of the NSP 20. Or else, an arrangement can be made between the company 40 and the NSP20 for remunerations according to the number of accesses made.

### Second Preferred Embodiment

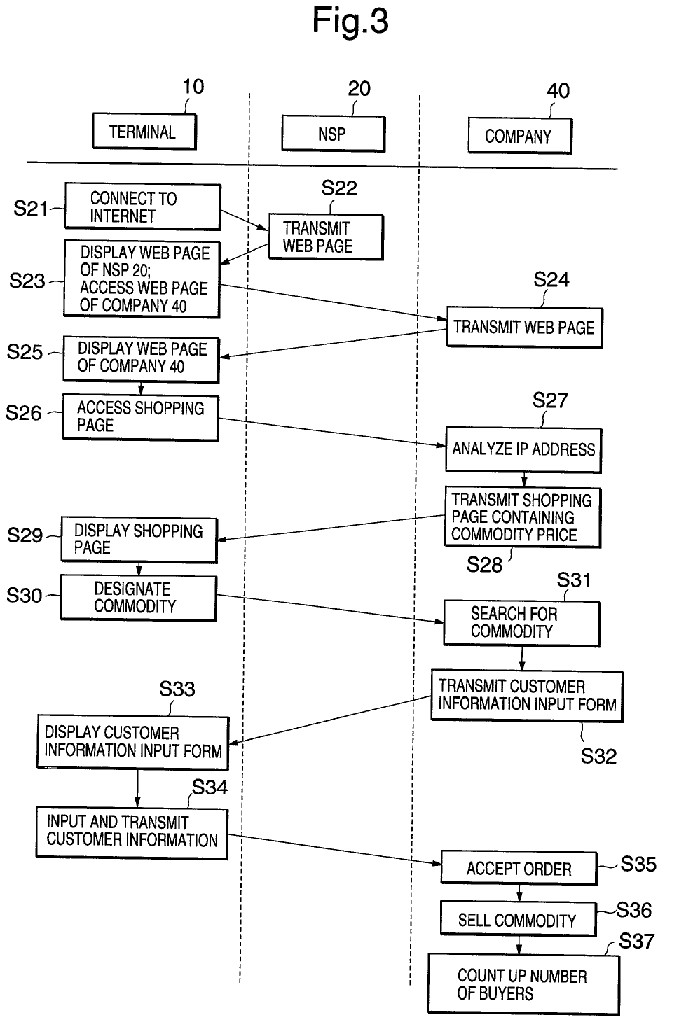

FIG. 3 is a flow chart for describing how a commodity selling method constituting a second preferred embodiment of the invention operates in the commodity selling system illustrated in FIG. 1.

A user, when to do on-line shopping, operates his or her terminal 10 to instruct establishment of connection to the Internet 30 (step S21).

The NSP 20, having a contract with the user of the terminal 10, transmits its web page to the terminal 10 when the terminal 10 instructs establishment of connection to the Internet 30 (step S22).

When the web page of the NSP 20, transmitted from the NSP 20, is displayed on the screen of the terminal 10, the user accesses the web page of the company 40 on which to do on-line shopping (step S23).

Then, the web page of the company 40 is transmitted to the terminal 10 (step S24), and displayed on the screen of the terminal 10 (step S25).

After that, when the user accesses a shopping page of the company 40 whose link is pasted onto the web page of the company 40 (step S26), an IP address transmitted from the terminal 10 is analyzed at the company 40, and the NSP via which the terminal 10 has accessed the company 40 is identified accordingly (step S27).

The company 40, on the basis of the number of commodity buyers via the identified NSP, offers a discount price for an order placed via an NSP via which many users have bought commodities so far. It is conceivable, for instance, to set a discount rate for each NSP according to the number of commodity buyers in the past or to discount the prices of commodities ordered via an NSP via which a greater number of buyers than a predetermined level have placed orders. The number of commodity buyers is accumulated for each NSP in a database (not shown) in the company 40.

On the basis of identification at step S27, a shopping page of the company 40 containing the price of the commodity set for the particular NSP is transmitted to the terminal 10 (step S28), and displayed on the screen of the terminal 10 (step S29).

When the user designates a desired commodity out of the shopping page displayed on the terminal 10 (step S30), the company 40 searches for the designated commodity (step S31).

After that, the company 40 transmits a customer information input form, to be filled with customer information, to the terminal 10 (step S32).

The customer information input form transmitted from the company 40 is displayed on the screen of the terminal 10 (step S33), and the user enters his or her customer information into the customer information input form displayed on the screen of the terminal 10, and transmits it to the company 40 (step S35). Then the commodity is sold to the user of the terminal 10 (step S36).

Then, 1 is added to the number of commodity buyers via the NSP 20, accumulated in the database (step S37).

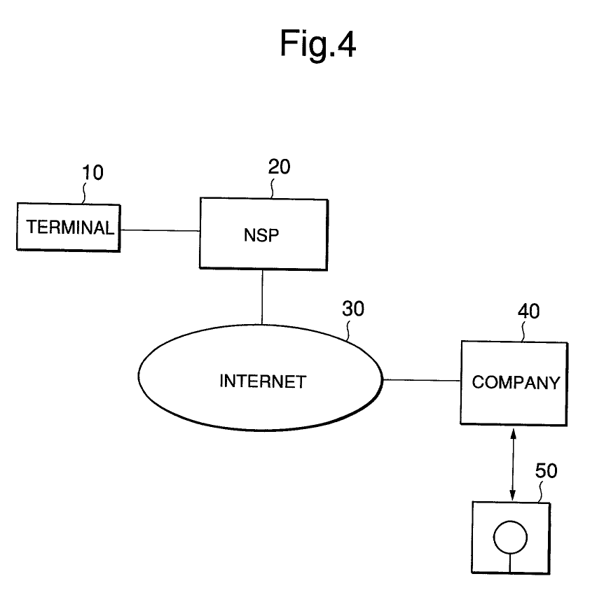

Furthermore, to refer to FIG. 4, either embodiment of the invention may include a storage medium 50. The server computer installed at the company 40 loads the program recorded on this storage medium 50 and, under the control of the loaded program, causes the company 40 to operate as shown in FIG. 2 or 3. The storage medium 50 may be a magnetic disk, a semiconductor memory or any other appropriate storage medium, and the program may be divided to store each divided segment on one or another of a plurality of grouped storage media. Loading of the program from the storage medium 50 may be accomplished via a signal line.

Since the present invention has a configuration enabling commodity prices to be set according to the number of users having made purchases via a given NSP as hitherto described, it provides the following advantages.

(1) A user, if he or she buys a commodity via an NSP via which many users have bought commodities so far, can buy the commodity at a lower price than via any other NSP.

(2) An NSP can attract more members with the price discounts for commodities it handles.

(3) If the NSP 20 actively advertises commodities to enlarge the membership, it can further strengthen the promotion of commodities.

What is claimed is:

1. A commodity selling method comprising steps of:
accepting a request for connection from a terminal unit via one of a plurality of NSPs;
identifying the NSP via which said request for connection came; and
setting the price of a commodity according to said identified NSP.

2. The method as claimed in claim 1, wherein:
the identification of said NSP is based on the IP address of said terminal unit contained in said request for connection.

3. The method as claimed in claim 1, wherein:
the setting of the price of said commodity is based, with respect to each of said plurality of NSPs, on the number of buyers having bought commodities in the past via the NSP.

4. A commodity selling apparatus comprising:
a receiving device for accepting a request for connection from a terminal unit via one of a plurality of NSPs;
an identifying device for identifying the NSP via which said request for connection came; and
a setting device for setting the price of a commodity according to said identified NSP.

5. The apparatus as claimed in claim 4, wherein:
said identifying device identifies said NSP on the basis of the IP address of said terminal unit contained in said request for connection.

6. The apparatus as claimed in claim 4, wherein:
said setting device sets the price of said commodity, with respect to each of said plurality of NSPS, on the basis of the number of buyers having bought commodities in the past via the NSP.

7. A commodity selling program, said program enabling a computer to execute:
processing to accept a request for connection from a terminal unit via one of a plurality of NSPs;
processing to identify the NSP via which said request for connection came; and
processing to set the price of a commodity according to said identified NSP.

8. The program as claimed in claim 7, wherein:
the identification of said NSP is based on the IP address of said terminal unit contained in said request for connection.

9. The program as claimed in claim 7, wherein:
the setting of the price of said commodity is based, with respect to each of said plurality of NSPs, on the number of buyers having bought commodities in the past via the NSP.
